(19) United States
(12) Patent Application Publication
(10) Pub. No.: US 2024/0406212 A1
(43) Pub. Date: Dec. 5, 2024

(54) Network device with datagram transport layer security

(71) Applicant: Mellanox Technologies, Ltd., Yokneam (IL)

(72) Inventors: Boris Pismenny, Lausanne (CH); Miriam Menes, Tel Aviv (IL); Liran Liss, Atzmon -Segev (IL)

(21) Appl. No.: 18/595,475

(22) Filed: Mar. 5, 2024

(30) Foreign Application Priority Data
Jun. 1, 2023 (IL) 303397

(51) Int. Cl. H04L 9/40; H04L 9/08

(52) U.S. Cl. CPC H04L 63/166; H04L 9/0891

(57) ABSTRACT

In one embodiment, a local networking device includes a host interface to receive packets from a local host device, packet processing hardware to receive cryptographic material offloaded from the local host device over the host interface, perform cryptographic operations on the packets based on the cryptographic material, generate datagram transport layer security (DTLS) headers including respective DTLS sequence numbers in hardware, and encapsulate the packets with the DTLS headers in hardware, and a network interface to send the packets with the DTLS headers to a remote networking device over a packet data network.

### FIELD OF THE INVENTION

The present invention relates to computer systems, and in particular, but not exclusively to, a network device with transport layer security.

### BACKGROUND

The Datagram Transport Layer Security (DTLS) Protocol (e.g., Version 1.3) is used to secure User datagram protocol (UDP) traffic and in addition to providing security features (such as preventing eavesdropping, tampering, or message forgery), also includes other features included in Transmission Control Protocol (TCP), but not included in UDP (such as packet reordering, and processing loss of datagram and data larger than the size of a datagram network packet for handshake messages).

DTLS is managed at the host level, with host devices (e.g., client-server software) setting up a DTLS session including establishing cryptographic information (such as keys) and then managing the session including generating DTLS headers and performing cryptographic operations such as encryption, decryption, and authentication etc.

### SUMMARY

There is provided in accordance with an embodiment of the present disclosure, a system, including a local networking device, including a host interface to receive first packets from a local host device, packet processing hardware to receive first cryptographic material offloaded from the local host device over the host interface, perform cryptographic operations on the first packets based on the first cryptographic material, generate first datagram transport layer security (DTLS) headers including respective DTLS sequence numbers in hardware, and encapsulate the first packets with the first DTLS headers in hardware, and a network interface to send the first packets with the first DTLS headers to a remote networking device over a packet data network.

Further in accordance with an embodiment of the present disclosure the first packets include remote direct memory access (RDMA) packets.

Still further in accordance with an embodiment of the present disclosure the network interface is to receive from the remote networking device over the packet data network second packets having headers including second DTLS headers, the packet processing hardware is to parse the headers of the second packets, construct second cryptographic material from at least one of the second DTLS headers, find at least one decryption key in the first cryptographic material based on source and destination data in at least one of the second DTLS headers, decrypt and authenticate the second packets based on the at least one decryption key and the second cryptographic material, and perform replay protection checks based on DTLS sequence numbers of the second packets.

Additionally in accordance with an embodiment of the present disclosure the packet processing hardware is to check a DTLS data type of the second packets, pass control packets of the second packets to host software running on the local host device, and decapsulate data packets of the second packets.

Moreover, in accordance with an embodiment of the present disclosure the packet processing hardware is to perform a direct memory access operation of a host memory of the local host device after decapsulating the data packets.

Further in accordance with an embodiment of the present disclosure the packet processing hardware is to retain the DTLS sequence numbers of the first packets in plaintext for sending to the remote networking device.

Still further in accordance with an embodiment of the present disclosure the packet processing hardware is to generate header fields of the first DTLS headers at a fixed length per header field.

Additionally in accordance with an embodiment of the present disclosure the packet processing hardware is to receive a key update DTLS control message from the local host device, generate a DTLS sequence number for the key update DTLS control message, save the DTLS sequence number for the key update DTLS control message to a memory of the local host device, add a DTLS header to the key update DTLS control message in hardware, the DTLS header of the key update DTLS control message including the DTLS sequence number of the key update DTLS control message, send the key update DTLS control message to a remote host device, receive from the remote host device an acknowledgment DTLS control message including the DTLS sequence number of the key update message as an acknowledgement message of the key update message, provide the acknowledgment DTLS control message to software running on the local host device, and receive offload of the new cryptographic material from the software.

Moreover in accordance with an embodiment of the present disclosure, the system includes the local host device including a processor to run the software to generate the key update DTLS control message, provide the key update DTLS control message to the local networking device, receive the acknowledgment DTLS control message from the local networking device, retrieve the DTLS sequence number of the key update DTLS control message, verify that the DTLS sequence number of the key update message corresponds with a DTLS sequence number of the acknowledgement message, and offload the new cryptographic material to the local networking device responsively to verifying that the DTLS sequence number of the key update message corresponds with the DTLS sequence number of the acknowledgement message.

Further in accordance with an embodiment of the present disclosure, the system includes the local host device including a processor to run software to establish a DTLS connection with a remote host device using a DTLS handshake, and offload the first cryptographic material to the local networking device.

Still further, in accordance with an embodiment of the present disclosure the software running on the processor of the local host device is to generate each of the first packets with a single DTLS record.

Additionally in accordance with an embodiment of the present disclosure the software running on the processor of the local host device is to generate each of the first packets with a same padding length.

Moreover in accordance with an embodiment of the present disclosure the packet processing hardware is to receive an instruction from software running on the local host device to drop any DTLS packets received from the remote networking device prior to offload of the first cryptographic material from the local host device being completed, and drop second DTLS packets received prior to completing offload of the first cryptographic material from the local host device.

Further in accordance with an embodiment of the present disclosure, the system includes the local host device including a processor to run the software to perform a DTLS handshake with a remote host device, provide the instruction to the local networking device to drop any DTLS packets received from the remote networking device prior to offload of the first cryptographic material from the local host device being completed, complete the DTLS handshake, and offload the first cryptographic material to the local networking device after completing the DTLS handshake.

Still further in accordance with an embodiment of the present disclosure in response to receiving the first cryptographic material offloaded from the local host device, the packet processing hardware is to generate a DTLS request to a remote host device to commence offload of second cryptographic material to the remote networking device, the packet processing hardware is to receive a DTLS response from the remote networking device that the second cryptographic material has been offloaded to the remote networking device by the remote host device, the DTLS response being generated by the remote networking device, and in response to receiving the DTLS response, the packet processing hardware is to commence sending DTLS data messages to the remote networking device.

Additionally in accordance with an embodiment of the present disclosure, the system includes the local host device including a processor to run software to receive a DTLS request generated by the remote networking device requesting to commence offload of the first cryptographic material to the local networking device, and in response to receiving the DTLS request, offload the first cryptographic material to the local networking device, wherein the packet processing hardware of the local networking device is to generate a DTLS response to the remote networking device indicating that the offload of the first cryptographic material to the local networking device has been completed.

Moreover in accordance with an embodiment of the present disclosure the packet processing hardware is to in response to receiving the offload of the first cryptographic material from the local host device, generate a first DTLS finished message and send the first DTLS finished message to a remote host device, and receive a second DTLS finished message generated by the remote networking device indicating that the offload of the first cryptographic material to the remote networking device has been completed.

Further in accordance with an embodiment of the present disclosure, the system includes the local host device including a processor to run software to receive a first DTLS finished message from the remote host device, and offload the first cryptographic material to the local networking device, wherein the packet processing hardware of the local networking device is to generate a second DTLS finished message and send the second DTLS finished message to the remote networking device, and commence sending DTLS data messages to the remote networking device.

There is also provided in accordance with another embodiment of the present disclosure, a host device, including a processor to run software to establish a DTLS connection with a remote host device using a DTLS handshake, and offload cryptographic material of the DTLS connection to a local networking device, and an interface to provide the cryptographic material to the local networking device.

Still further in accordance with an embodiment of the present disclosure the software is to generate a key update DTLS control message, provide the key update DTLS control message to the local networking device, receive an acknowledgment DTLS control message from the local networking device, retrieve a DTLS sequence number of the key update DTLS control message, verify that the DTLS sequence number of the key update message corresponds with a DTLS sequence number of the acknowledgement message, and offload new cryptographic material to the local networking device responsively to verifying that the DTLS sequence number of the key update message corresponds with the DTLS sequence number of the acknowledgement message.

Additionally in accordance with an embodiment of the present disclosure the software is to generate DTLS packets with a single DTLS record.

Moreover, in accordance with an embodiment of the present disclosure the software is to generate DTLS packets with a same padding length.

Further in accordance with an embodiment of the present disclosure the software is to provide an instruction to the local networking device to drop any DTLS packets received from a remote networking device prior to offload of the cryptographic material to the local networking device being completed, complete the DTLS handshake, and offload the cryptographic material to the local networking device after completing the DTLS handshake.

Still further in accordance with an embodiment of the present disclosure the software is to receive a DTLS request generated by a remote networking device requesting to commence offload of the cryptographic material to the local networking device, and in response to receiving the DTLS request, offload the cryptographic material to the local networking device.

Additionally in accordance with an embodiment of the present disclosure the software is to receive a DTLS finished message from the remote host device, and offload the cryptographic material to the local networking device.

There is also provided in accordance with still another embodiment of the present, disclosure a method, including receiving packets from a local host device, receiving cryptographic material offloaded from the local host device over a host interface, performing cryptographic operations on the packets based on the cryptographic material, generating datagram transport layer security (DTLS) headers including respective DTLS sequence numbers in hardware, encapsulating the packets with the DTLS headers in hardware, and a network interface to send the packets with the DTLS headers to a remote networking device over a packet data network.

### BRIEF DESCRIPTION OF THE DRAWINGS

The present invention will be understood from the following detailed description, taken in conjunction with the drawings in which:

FIG. 1 is a block diagram view of secure communication system constructed and operative in accordance with an embodiment of the present invention;

FIGS. 2A-D are views of packet formats and settings for use in the system of FIG. 1;

FIG. 3 is a flowchart including steps in a method of outbound packet processing in the system of FIG. 1;

FIG. 4 is a flowchart including steps in a method of inbound packet processing in the system of FIG. 1;

FIG. 5 is a flow diagram including steps in a first offload method in the system of FIG. 1;

FIG. 6 is a flow diagram including steps in a second offload method in the system of FIG. 1;

FIG. 7 is a flow diagram including steps in a third offload method in the system of FIG. 1; and

FIG. 8 is a flow diagram including steps in a rekey method in the system of FIG. 1.

### DESCRIPTION OF EXAMPLE EMBODIMENTS

### Overview

It may be desirable, or even necessary in certain cases, to perform cryptographic operations in a networking device, such as a network interface controller (NIC). For example, remote direct memory access (RDMA) allows a host device to write directly to (or read directly from) the memory of a remote host device (i.e., over a network) via a remote NIC attached to the remote host device without having the operating system of the remote host device process the RDMA request. In such a case, the remote NIC needs to be able to decrypt/encrypt data before writing it to the host memory or decrypt/encrypt data read from the host memory for sending to the requesting host device. Therefore, there is a need for a NIC to perform cryptographic operations.

Embodiments of the present invention address at least some of the above drawbacks by providing a security layer protocol such as DTLS in a networking device (e.g., NIC). The DTLS connection is established by host devices and then security layer protocol functionality (such as DTLS functionality) is offloaded to networking devices attached to the host devices.

In some embodiments, the host devices set up a DTLS connection using a handshake which includes hello messages for example. DTLS sequence numbers are used as part of the handshake. The handshake also includes establishing cryptographic information (such as cryptographic key material) for use in secured communications. At this stage, the DTLS headers are generated by the host devices. Each host device offloads the cryptographic information to its network device (e.g., via the host memory) for use in secured communications between the network devices. The cryptographic information may be offloaded to the network devices by the respective host devices after finishing the handshake, or as part of finishing the handshake, as described in disclosed embodiments.

The network devices then communicate with each other, generate and process DTLS headers (instead of the host devices), and perform cryptographic operations (using the offloaded cryptographic information and optionally cryptographic information included in the DTLS headers) instead of the host devices. The network devices may perform any suitable action, for example, a RDMA read or write based on a received DTLS packet. The above may be performed using a standard DTLS protocol header for example.

New keys may be supplied to the network devices using a rekey process which operates via the host devices and the network devices, as described in disclosed embodiments. To operate efficiently certain changes and/or restrictions to the DTLS protocol are optionally implemented, as described in disclosed embodiments.

### System Description

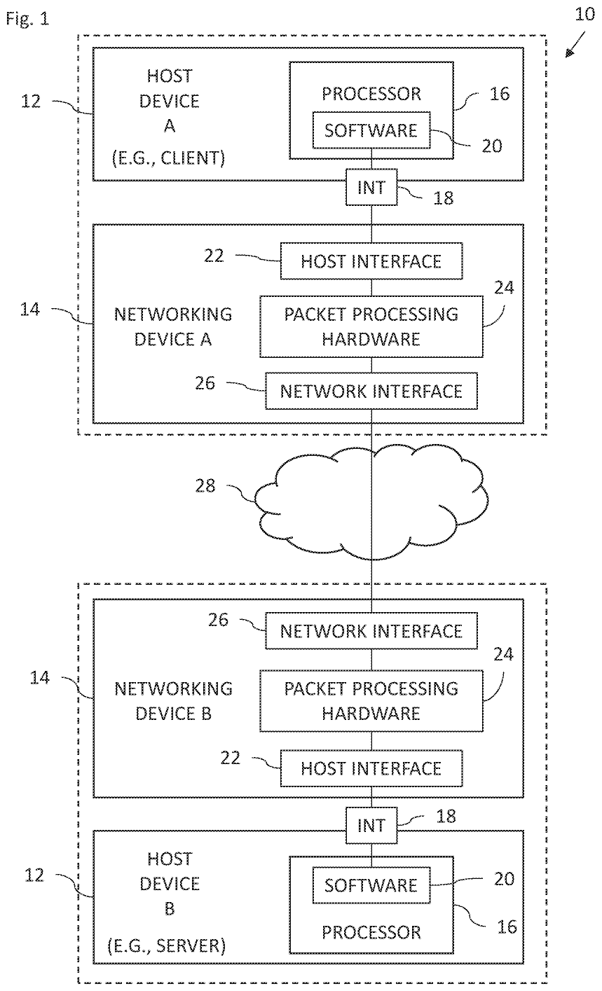

Reference is now made to FIG. 1, which is a block diagram view of secure communication system 10 constructed and operative in accordance with an embodiment of the present invention.

The system 10 includes two host devices 12, and two networking devices 14 (e.g., NICs). The host devices 12 are referred to as host device A and host device B for simplicity of reference. Similarly, the networking devices 14 are referred to as networking device A and networking device B for simplicity of reference. Host device A may connect via networking device A, a packet data network 28, and networking device B to host device B.

Each host device 12 includes a processor 16 and an interface 18. The processor 16 is configured to run software 20. The interface 18 is configured to connect to a local one of the networking devices 14. Each networking device 14 includes a host interface 22, packet processing hardware 24, and a network interface 26. The host interface 22 is configured to connect to the local host device 12. The network interface 26 is configured to connect across the packet data network 28 to other devices.

The host devices 12 may be any suitable devices. In the example of FIG. 1 host device A is a client device and host device B is a server device. With respect to host device A, networking device A is a local networking device, while networking device B is a remote networking device, and host device B is a remote host device. With respect to host device B, networking device B is a local networking device, while networking device A is a remote networking device, and host device A is a remote host device. With respect to networking device A, host device A is a local host device, while networking device B is a remote networking device, and host device B is a remote host device. With respect to networking device B, host device B is a local host device, while networking device A is a remote networking device, and host device A is a remote host device. A remote device of a given device is defined as a device connected to the given device over the packet data network 28. A local device of a given device is defined as a host device of the given device or as a peripheral device of the given device and connected via a connection which is not a network connection.

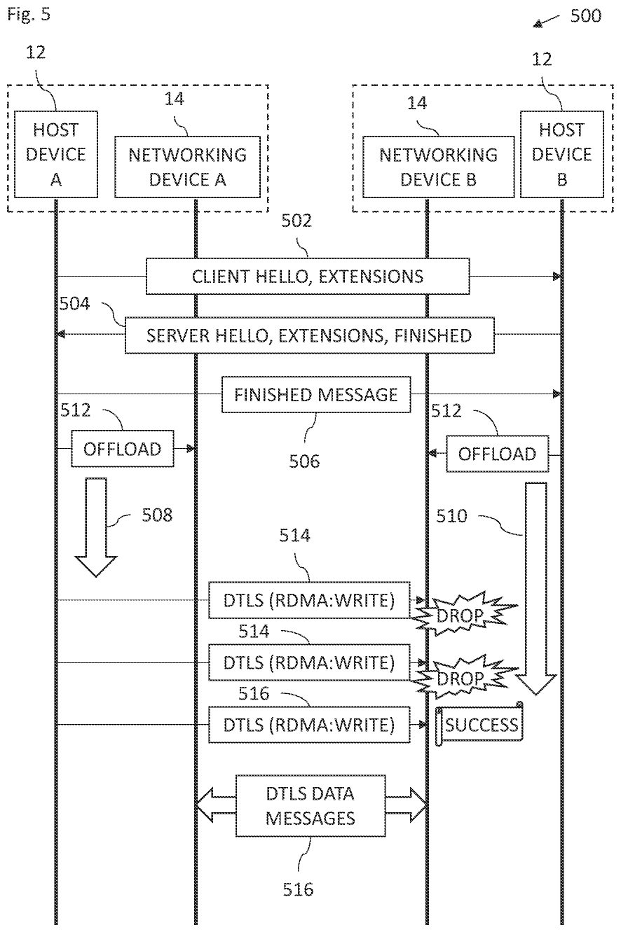

The software 20 running on each host device 12 is configured to establish a DTLS connection with the remote host device 12 using a DTLS handshake and offload cryptographic material of the DTLS connection to its local networking device 14 as described in more detail with reference to FIGS. 5-7. The interface 18 of each host device 12 is configured to send or provide the cryptographic material to its local networking device 14. In other words, host device A offloads cryptographic material to networking device A, and host device B offloads cryptographic material to networking device B.

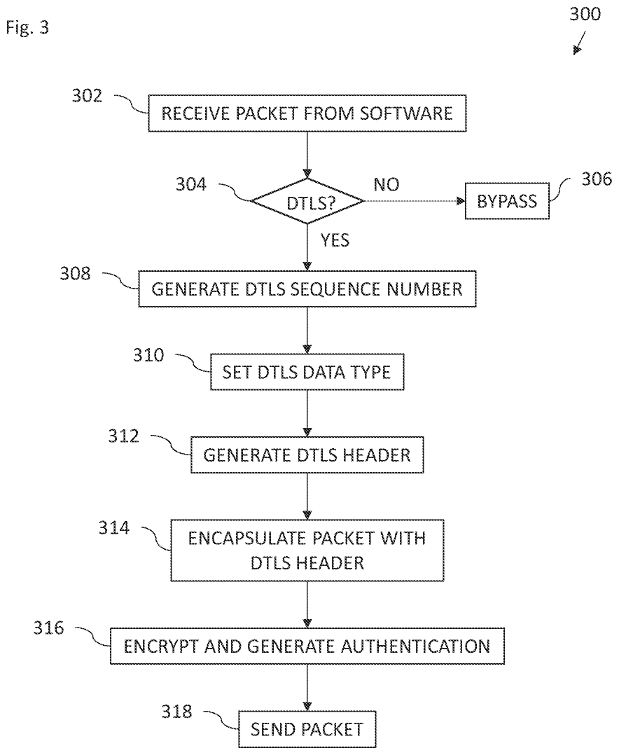

The host interface 22 of each networking device 14 is configured to receive packets from its local host device 12. The packet processing hardware 24 of each networking device 14 is configured to: receive the cryptographic material offloaded from its local host device 12 over the host interface 22; perform cryptographic operations (e.g., encryption) on the received packets based on the cryptographic material; generate DTLS headers including respective DTLS sequence numbers in hardware; and encapsulate the packets with the DTLS headers in hardware. The network interface 26 of each networking device 14 is configured to send the encapsulated packets with the DTLS headers to the remote networking device 14 over the packet data network 28. The packets may include remote direct memory access (RDMA) packets. The above is described in more detail with reference to FIG. 3.

In practice, some or all of the functions of the processor 16 may be combined in a single physical component or, alternatively, implemented using multiple physical components. These physical components may comprise hard-wired or programmable devices, or a combination of the two. In some embodiments, at least some of the functions of the processor 16 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

### Changes/Restrictions to the DTLS Protocol

As previously mentioned, for the networking devices 14 to operate efficiently certain changes and/or restrictions to the DTLS protocol may be applied. It should be noted that some of the changes and/or restrictions relate to DTLS headers and therefore the networking devices 14 preparing the DTLS headers apply the changes and/or restrictions. Whereas some of the changes and/or restrictions relate to the payload (e.g., records per packet and padding) and therefore the host devices 12 preparing the DTLS records apply the changes and/or restrictions.

The changes and/or restrictions may include one or more of the following:
1. Have a single DTLS record per packet (as opposed to one UDP payload including multiple DTLS records (messages) per packet). This may be done to avoid recirculating packets in hardware DTLS logic. If a packet with multiple records is received, hardware may identify it by comparing the UDP length to the DTLS message length and drop the packet. It is also possible to forgo the aforementioned check when the protocol provides a way to guarantee that the above will not occur, and in that case multi-record packets will be dropped based on authentication check, e.g., expecting the final authentication tag to match the whole packet and not just the last DTLS record in a packet.
2. Prohibit variable length padding. This may be done to simplify the lookup of the real DTLS record type. DTLS 1.3 introduced variable zero padding at the trailer that is processed sequentially to find the real DTLS record type. This sequential process increases latency.
3. DTLS record sequence numbers in the DTLS headers should remain in plaintext (i.e., not be in ciphertext). DTLS 1.3 encrypts the record sequence number to reduce ossification and increase privacy. The processing of encrypted record sequence numbers requires an extra layer of encryption to be applied to the packet after the payload is encrypted. This extra encryption adds latency to packet processing. Since plaintext DTLS record sequence numbers are not supported by the first release of DTLS 1.3, an extension to the DTLS1.3 protocol is desirable to comply with the standard and avoid record sequence number encryption.
4. Use fixed length header fields. The DTLS1.3 standard allows peers to use variable length encoding to DTLS record header fields. Parsing variable length encoding in hardware match and action units is more costly in terms of memory and processing and should thus be avoided.

Therefore, the software 20 running on the processor 16 of each host device 12 may be configured to generate each packet (which will receive a DTLS header) with a single DTLS record. Similarly, the software 20 running on the processor 16 of each host device 12 may be configured to generate each packet (that will receive a DTLS header) with the same padding length. Each networking device 14 may be configured to keep the DTLS record sequence numbers in plaintext without encrypting the DTLS record sequence numbers, and/or use fixed length header fields for the DTLS headers.

### Packet Formats and In/Outbound Processing

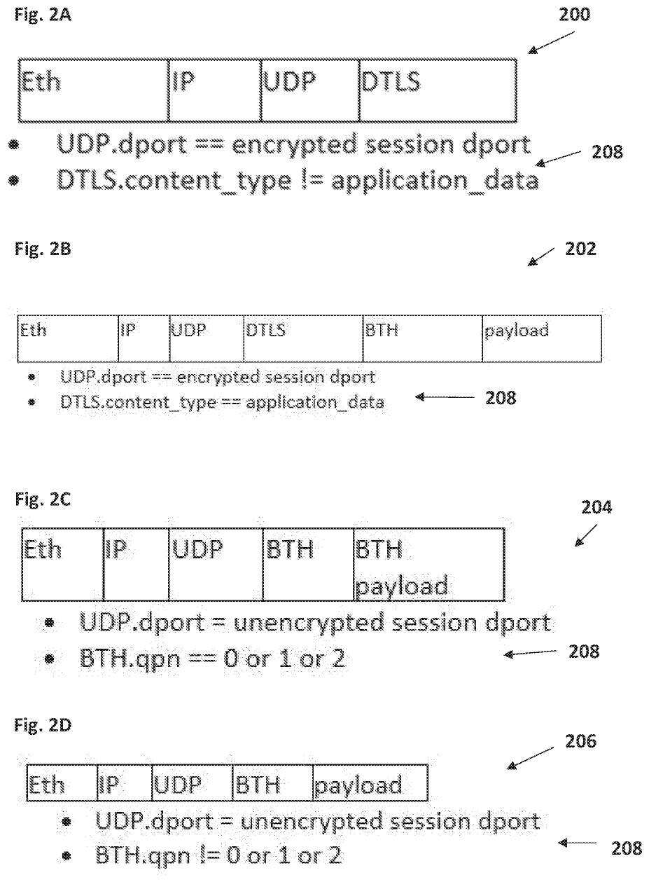

Reference is now made to FIGS. 2A-D, which are views of packet formats and settings 208 for use in the system of FIG. 1. FIG. 2A is a view of a control packet 200 when encryption is used. FIG. 2B is a view of a data packet 202 when encryption is used. FIG. 2C is a view of a non-encrypted control packet 204, and FIG. 2D is a view of a non-encrypted data packet 206. FIGS. 2A-D show the following: an Ethernet (“Eth”) header; an IP header; a UDP header; a DTLS header; and a Base Transport Header (BTH); and payloads.

The system 10 provides two modes for encryption offload. One mode, “partial” offload includes offloading encryption and decryption to the networking devices 14, while “full” offload includes offloading encryption, decryption, replay protection, encapsulation, and decapsulation to the networking devices 14.

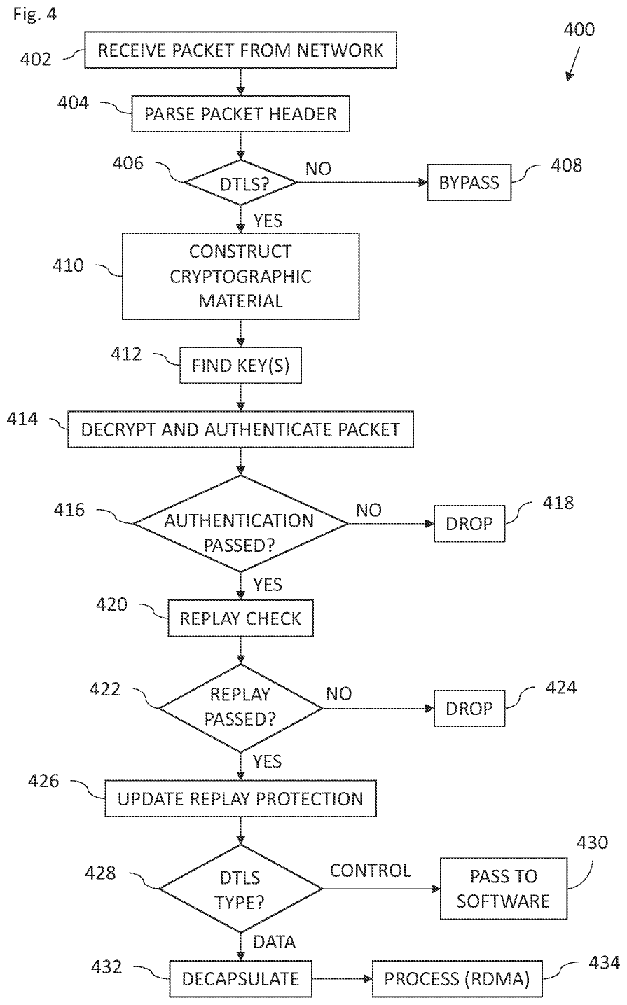

In some embodiments, the basic primitive to offload encryption resides in steering. Steering includes a series of programmable match and action operations that includes among others: packet encapsulation and decapsulation, header rewrite, counting packets/bytes, header push/pop, and selecting receive queue/core. With encryption, on both receive and transmit side, steering may encrypt/decrypt/authenticate packet payload using a key that is chosen based on parsed packet fields and/or work queue entry (WQE) metadata. Additionally, hardware may perform replay protection and sequence generation for packets going through steering. Steering is described in more detail with reference to FIGS. 3 and 4.

Full offload may be implemented for RDMA to process the encrypted BTH header. The main challenge with encryption of traffic is as follows: on the one hand, (de) encapsulation in the networking devices 14 is not always desirable, for instance, when the packet is a handshake message, the DTLS sequence number is used for reliable delivery (i.e., “ACK” records) and the software 20 needs to observe and use the DTLS sequence number; on the other hand, to guarantee replay protection all packets must update the replay protection bitmap in hardware in the networking devices 14.

Embodiments of the present invention address the above drawbacks by the packet processing hardware 24 in the networking devices 14 performing (de) encryption, replay protection, and sequence number generation even for DTLS handshake messages as described in more detail with reference to FIG. 4. The software 20 sending DTLS handshake messages receives the DTLS sequence number(s) used to send the relevant packets from the hardware of the networking devices 14. The DTLS sequence number may be provided by the networking device 14 reporting the sequence number in the completion notice of a processed packet (i.e., a notice generated when the packet is scattered to memory) or by querying hardware stored registers. The latter is generally slower.

Reference is now made to FIG. 3, which is a flowchart 300 including steps in a method of outbound packet processing in system 10 of FIG. 1. The packet processing hardware 24 of one of the networking devices 14 is configured to receive a packet from software 20 via the host interface 22 (block 302). The packet processing hardware 24 is configured to check at a decision block 304 if the packet is a DTLS packet. If the packet is not a DTLS packet, the DTLS processing shown in FIG. 3 is bypassed (block 306). If the packet is a DTLS packet, then the DTLS processing shown in FIG. 3 is performed in any suitable order. The packet processing hardware 24 is configured to generate a DTLS sequence number for the packet (block 308), set the DTLS data type to control packet or data packet accordingly (block 310), generate a DTLS header for the packet (block 312), encapsulate the packet with the generated DTLS header (block 314), and encrypt the packet and generate authentication data (i.e., to be used by a remote device to authenticate the packet data) (block 316). If a sequence number is generated for a control message, the packet processing hardware 24 is configured to write the generated sequence number to host memory and the software 20 may then query the host memory at a later stage to find the sequence number that was sent to another device.

The network interface 26 of the networking device 14 is configured to send the packet to the remote networking device 14 (block 318).

In some embodiments, the packet processing hardware 24 is configured to retain the DTLS sequence numbers of the packets to be sent in plaintext for sending to the remote networking device 14. In some embodiments, the packet processing hardware 24 is configured to generate header fields of the DTLS headers at a fixed length per header field (i.e., may use a different length for different header fields but not variable length for any one header field).

Reference is now made to FIG. 4, which is a flowchart 400 including steps in a method of inbound packet processing in the system 10 of FIG. 1. The network interface 26 of one of the networking devices 14 is configured to receive from the remote networking device 14 over the packet data network 28 packets (at least some of which having headers including DTLS headers) (block 402). For each received packet the following processing is performed.

The packet processing hardware 24 is configured to parse the header of the received packet (block 404), and check at a decision block 406 if the packet is a DTLS packet. If the packet is not a DTLS packet, then the DTLS processing of FIG. 4 is bypassed (block 408). If the packet is a DTLS packet, then the DTLS processing of FIG. 4 is performed in any suitable order.

The packet processing hardware 24 is configured to construct cryptographic material (e.g., initialization vector and other data used in decryption and authentication) from the DTLS header of the received packet (block 410). The packet processing hardware 24 is configured to find one or more decryption keys in the constructed cryptographic material based on 5-tuple data (e.g., source and destination data in the DTLS header (block 412). The packet processing hardware 24 is configured to decrypt and authenticate the packet based on the decryption key(s) and the constructed cryptographic material (block 414). The packet processing hardware 24 checks if the authentication is verified at a decision block 416. If the authentication is not verified, the packet processing hardware 24 is configured to drop the packet (block 418). If the authentication is verified, the packet processing hardware 24 is configured to perform a replay protection check based on the DTLS sequence number of the packet (block 420). The packet processing hardware 24 checks if the replay protection check is successful at a decision block 422. If the replay check is unsuccessful, the packet processing hardware 24 is configured to drop the packet (block 424). If the replay check is successful, the packet processing hardware 24 is configured to update replay protection data with the DTLS sequence number of the packet (block 426). At a decision block 428, the packet processing hardware 24 is configured to check a DTLS data type of the packet. If the packet is a control packet, the packet processing hardware 24 is configured to pass the control packet to software 20 running on the local host device 12 (block 430). If the packet is a data packet, the packet processing hardware 24 is configured to decapsulate the data packet (block 432) and process the packet (block 434) such as perform a direct memory access operation of a host memory of the local host device 12 after decapsulating the data packet.

### Races During Initialization

When switching to full offload from the host devices 12 to the networking devices 14 or to a new set of keys (i.e., rekey) with full offload, the software 20 software passes the state used for encryption and replay protection to hardware (i.e., the networking devices 14) for both receive and transmit processing. Software 20 should guarantee that no DTLS packet is sent or received between the time offload was requested and the time offload takes effect because such packets will be ignored by hardware and their replay may bypass hardware protection. For example, if offload has not yet occurred, the networking device 14 may erroneously forward RDMA packets to the local host device 12, and the local host device 12 will not know what to do with the RDMA packets. The description with reference to FIGS. 5-7 below describes different ways to address the above drawbacks.

Reference is now made to FIG. 5, which is a flow diagram 500 including steps in a first offload method in the system 10 of FIG. 1. In the method of FIG. 5, offload is performed after the DTLS handshake has completed. This leads to a race condition between a receiver networking device 14 being ready to receive DTLS packets and a sender networking device 14 sending packets. If packets are sent before the receiver networking device 14 is ready, drops will ensue. The receiver host device 12 configures its local networking device 14 to drop such DTLS packets before offload is completed. Once offload is completed the local networking devices 14 may process received DTLS packets.

Software 20 running on processor 16 of host device A is configured to send a client hello and extensions to host device B (block 502). Software 20 running on processor 16 of host device B is configured to perform a DTLS handshake with the remote host device (i.e., host device A) and sends a server hello, extensions, and a finished message (block 504). Software 20 running on processor 16 of host device B is configured to complete the DTLS handshake from its side. Prior to sending the finished message, the software 20 running on processor 16 of host device B is configured to provide an instruction to local networking device 14 (networking device B) to drop any DTLS packets received from remote networking device A prior to offload of cryptographic material from local host device B being completed. The packet processing hardware 24 of networking device B is configured to receive the instruction from the software 20 running on local host device B to drop any DTLS packets received from the remote networking device A prior to offload of the cryptographic material from the local host device B being completed. Software 20 running on processor 16 of host device A is configured to respond with a finished message (block 506).

Software 20 running on the processor 16 of both host device A and host device B is configured to offload cryptographic material to the respective local networking devices 14 (i.e., host device A to networking device A, and host device B to networking device B) after completing the DTLS handshake (blocks 512). FIG. 5 shows that the offload is completed from host device A to networking device A (see arrow 508) quicker than the offload is completed from host device B to networking device B (see arrow 510). Therefore, if host device A or networking device A starts sending DTLS messages to networking device B, prior to the offload being completed in networking device B, the packet processing hardware 24 of networking device B is configured to drop the DTLS packets received prior to completing offload of the cryptographic material from the local host device B (blocks 514). DTLS messages received after offload to networking device B is completed are successfully processed by the networking device B (blocks 516).

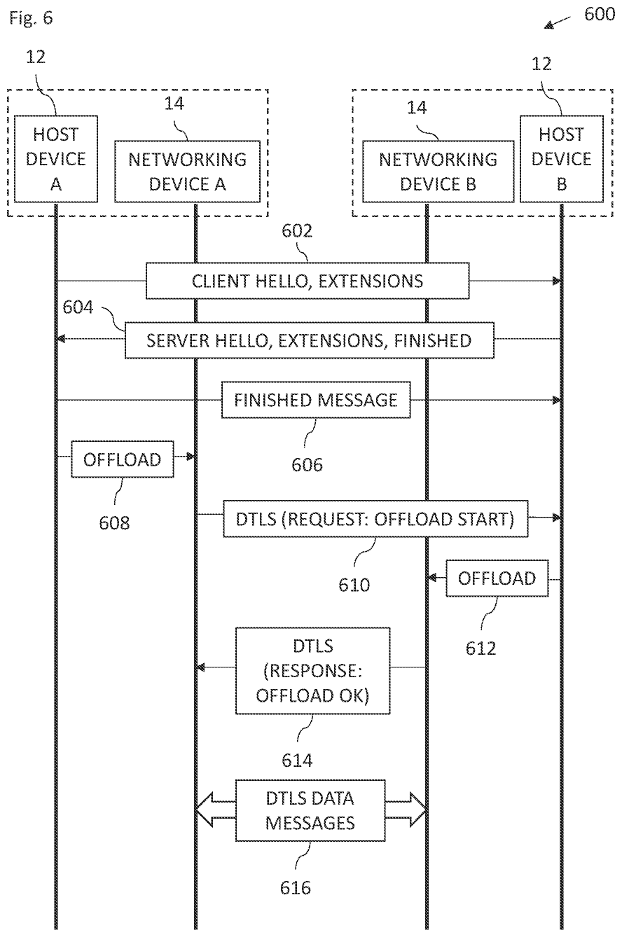

Reference is now made to FIG. 6, which is a flow diagram 600 including steps in a second offload method in the system 10 of FIG. 1. In the method of FIG. 6 the handshake commences and finishes as usual. An application layer protocol above DTLS performs another handshake after offload to establish that hardware is ready, as described in more detail below. RDMA or similar processing is repressed until the offload is complete.

Software 20 running on processor 16 of host device A is configured to send a client hello and extensions to host device B (block 602). Software 20 running on processor 16 of host device B is configured to perform a DTLS handshake with the remote host device (i.e., host device A) and sends a server hello, extensions, and a finished message (block 604). Software 20 running on processor 16 of host device B is configured to complete the DTLS handshake from its side. Software 20 running on processor 16 of host device A is configured to respond with a finished message (block 606).

Software 20 running on processor 16 of host device A is configured to offload cryptographic material to local networking device A (block 608). In response to receiving the cryptographic material offloaded from the local host device A, the packet processing hardware 24 of networking device A is configured to generate a DTLS request 610 to remote host device B to commence offload of cryptographic material to remote networking device B. Software 20 running on processor 16 of host device B is configured to receive the DTLS request 610 generated by remote networking device A requesting to commence offload of cryptographic material to local networking device B. In response to receiving the DTLS request 610, software 20 running on processor 16 of host device B is configured to offload cryptographic material to local networking device B (block 612).

The packet processing hardware 24 of networking device B is configured to generate a DTLS response 614 to remote networking device A indicating that the offload of cryptographic material to local networking device B has been completed. The packet processing hardware 24 of networking device A is configured to receive the DTLS response 614 from remote networking device B that the cryptographic material has been offloaded to remote networking device B by remote host device B. In response to receiving the DTLS response 614, the packet processing hardware 24 of networking device A is configured to commence sending DTLS data messages to remote networking device B (block 616).

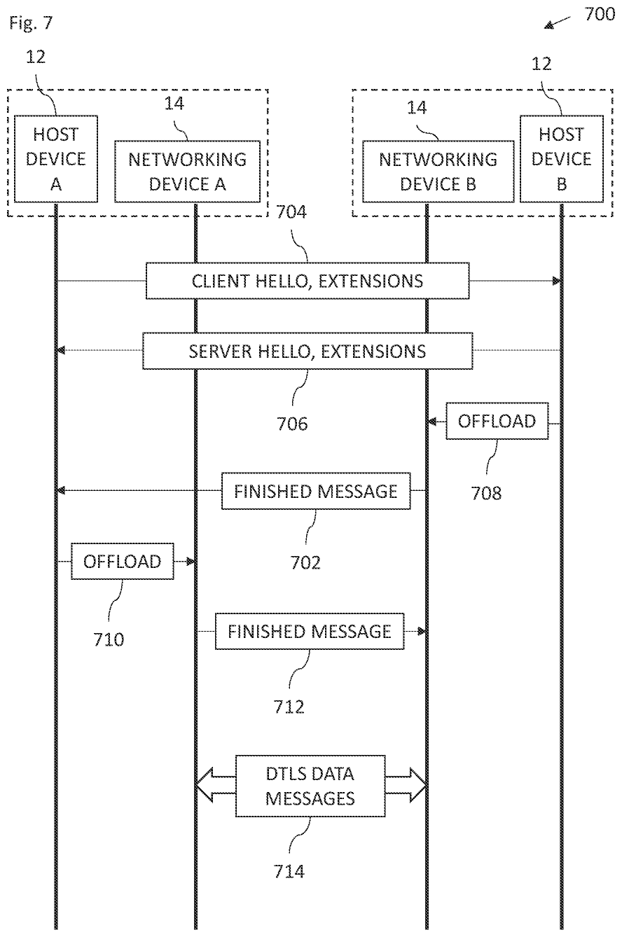

Reference is now made to FIG. 7, which is a flow diagram 700 including steps in a third offload method in the system 100 of FIG. 1. In the method of FIG. 7, the offload by the host devices 12 to the networking devices 14 forms part of the initialization handshake between the host devices 12 such that the handshake cannot make progress while offload is being set. Therefore, each respective host device 12 completes offload to its local networking device 14 before sending the “Finished” handshake message. Software 20 running on one of the host devices 12 relies on full offload to the local networking device 14 to build the DTLS record and set the sequence for sending the Finished message to the remote networking device 14.

Software 20 running on processor 16 of host device A is configured to send a client hello and extensions to host device B (block 704). Software 20 running on processor 16 of host device B is configured to send a server hello and extensions to host device A (block 706). Software 20 running on processor 16 of host device B is configured to offload cryptographic material to its local networking device B (block 708). The packet processing hardware 24 of networking device B is configured, in response to receiving the offload of the cryptographic material from the local host device B, to generate a DTLS finished message 702 and send the DTLS finished message 702 to remote host device A.

Software 20 running on processor 16 of host device A is configured to receive DTLS finished message 702 from remote host device B, and offload cryptographic material to local networking device A (block 710). The packet processing hardware 24 of networking device A is configured to generate a DTLS finished message 712 (in response to completing the offload of cryptographic material to networking device A) and send DTLS finished message 712 to remote networking device B. The packet processing hardware 24 of networking device B is configured to receive the DTLS finished message 712 indicating that the offload of cryptographic material to networking device A has been completed. The packet processing hardware 24 of networking device A is configured to commence sending DTLS data messages to networking device B (block 714).

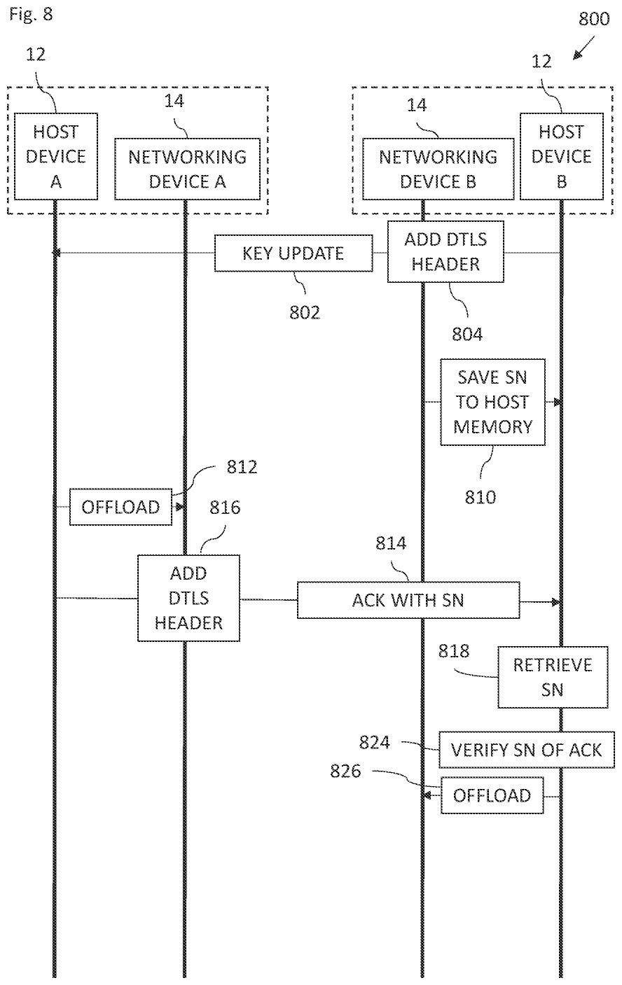

Reference is now made to FIG. 8, which is a flow diagram 800 including steps in a rekey method in the system 10 of FIG. 1. If new keys are needed in the middle of processing (e.g., in the middle of processing RDMA) after initial keys have been established, new keys can be negotiated between server and client using a key update message and acknowledgment. The rekeying is performed on the same connection as the RDMA processing. The headers of the key update and acknowledgment messages are handled in the networking devices 14 while the negotiation of the new key(s) is performed by the software 20 in the host devices 12.

In general, the packet processing hardware 24 on each host device 12 is configured to process DTLS control messages associated with rekey processing to update old cryptographic material with new cryptographic material as described in more detail below. Software 20 running on the processor 16 of host device B (e.g., a server) is configured to generate a DTLS control message as a key update message 802 and provide the key update message 802 to local networking device B.

The packet processing hardware 24 of networking device B is configured to receive the key update message 802 from local host device B and add a DTLS header to key update message 802 in hardware (block 804). The networking device B generates the DTLS sequence number to be included in the DTLS header. The DTLS sequence number is needed later in the rekey process by host device B (the server) to process the acknowledgement message from host device A (the client). Therefore, in some embodiments, the packet processing hardware 24 of networking device B saves the DTLS sequence number to memory of host device B (block 810) for later retrieval by software 20 running on host device B as described in more detail below. The packet processing hardware 24 of networking device B is configured to send key update message 802 with the DTLS header to remote host device A.

The packet processing hardware 24 of networking device A is configured to receive key update message 802 from host and networking device B, process key update message 802 according to the method described above with reference to FIG. 4, and provide key update message 802 (including the DTLS header of key update message 802) to software 20 running on processor 16 of local host device A.

Software 20 running on the processor 16 of host device A is configured to receive key update message 802 from the local networking device A, offload new cryptographic material (e.g., receiver keys) to local networking device A (block 812), generate a DTLS control message as an acknowledgement message 814 of the key update message 802 including the DTLS sequence number of the key update message 802, and provide the acknowledgement message 814 to the local networking device A for sending to host device B.

The packet processing hardware 24 of networking device A is configured to receive acknowledgement message 814, add a DTLS header to acknowledgement message 814 (block 816), and send acknowledgement message 814 with the DTLS header to remote networking device B.

The packet processing hardware 24 of networking device B is configured to receive acknowledgement message 814 from host and networking device A, process acknowledgement message 814 according to the method described above with reference to FIG. 4, and provide acknowledgement message 814 (including the DTLS header of acknowledgement message 814) to software 20 running on processor 16 of local host device B.

Software 20 running on the processor 16 of the local host device is configured to receive the acknowledgement message 814 from the local networking device B, and retrieve the DTLS sequence number of the key update message 802 from the host memory of host device B (block 818). It should be noted that the step of block 818 may be performed prior to receiving acknowledgement message 814.

Software 20 running on the processor 16 of host device B is configured to verify that the DTLS sequence number of the key update message 802 corresponds with the DTLS sequence number of the acknowledgement message 814 (block 824), and offload the new cryptographic material to local networking device B responsively (i.e. in response to) to verifying that the DTLS sequence number of the key update message 802 corresponds with the DTLS sequence number of the acknowledgement message 814 (block 826).

In some embodiments, the old cryptographic material remains in the packet processing hardware 24 for a predetermined period of time, and/or until some preconfigured number of packets using the new cryptographic material are processed by the packet processing hardware 24.

Various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination.

The embodiments described above are cited by way of example, and the present invention is not limited by what has been particularly shown and described hereinabove. Rather the scope of the invention includes both combinations and sub-combinations of the various features described hereinabove, as well as variations and modifications thereof which would occur to persons skilled in the art upon reading the foregoing description and which are not disclosed in the prior art.

What is claimed is:

1. A system, comprising a local networking device, including:
a host interface to receive first packets from a local host device;
packet processing hardware to:
receive first cryptographic material offloaded from the local host device over the host interface;
perform cryptographic operations on the first packets based on the first cryptographic material;
generate first datagram transport layer security (DTLS) headers including respective DTLS sequence numbers in hardware; and
encapsulate the first packets with the first DTLS headers in hardware; and
a network interface to send the first packets with the first DTLS headers to a remote networking device over a packet data network.

2. The system according to claim 1, wherein the first packets include remote direct memory access (RDMA) packets.

3. The system according to claim 1, wherein:
the network interface is to receive from the remote networking device over the packet data network second packets having headers including second DTLS headers;
the packet processing hardware is to:
parse the headers of the second packets;
construct second cryptographic material from at least one of the second DTLS headers;
find at least one decryption key in the first cryptographic material based on source and destination data in at least one of the second DTLS headers;
decrypt and authenticate the second packets based on the at least one decryption key and the second cryptographic material; and
perform replay protection checks based on DTLS sequence numbers of the second packets.

4. The system according to claim 3, wherein the packet processing hardware is to:
check a DTLS data type of the second packets;
pass control packets of the second packets to host software running on the local host device; and
decapsulate data packets of the second packets.

5. The system according to claim 4, wherein the packet processing hardware is to perform a direct memory access operation of a host memory of the local host device after decapsulating the data packets.

6. The system according to claim 1, wherein the packet processing hardware is to retain the DTLS sequence numbers of the first packets in plaintext for sending to the remote networking device.

7. The system according to claim 1, wherein the packet processing hardware is to generate header fields of the first DTLS headers at a fixed length per header field.

8. The system according to claim 1, wherein the packet processing hardware is to:
receive a key update DTLS control message from the local host device;
generate a DTLS sequence number for the key update DTLS control message;
save the DTLS sequence number for the key update DTLS control message to a memory of the local host device;
add a DTLS header to the key update DTLS control message in hardware, the DTLS header of the key update DTLS control message including the DTLS sequence number of the key update DTLS control message;
send the key update DTLS control message to a remote host device;
receive from the remote host device an acknowledgment DTLS control message including the DTLS sequence number of the key update message as an acknowledgement message of the key update message;
provide the acknowledgment DTLS control message to software running on the local host device;
and
receive offload of the new cryptographic material from the software.

9. The system according to claim 8, further comprising the local host device including a processor to run the software to:
generate the key update DTLS control message;
provide the key update DTLS control message to the local networking device;
receive the acknowledgment DTLS control message from the local networking device;
retrieve the DTLS sequence number of the key update DTLS control message;
verify that the DTLS sequence number of the key update message corresponds with a DTLS sequence number of the acknowledgement message; and
offload the new cryptographic material to the local networking device responsively to verifying that the DTLS sequence number of the key update message corresponds with the DTLS sequence number of the acknowledgement message.

10. The system according to claim 1, further comprising the local host device including a processor to run software to:
establish a DTLS connection with a remote host device using a DTLS handshake; and
offload the first cryptographic material to the local networking device.

11. The system according to claim 10, wherein the software running on the processor of the local host device is to generate each of the first packets with a single DTLS record.

12. The system according to claim 10, wherein the software running on the processor of the local host device is to generate each of the first packets with a same padding length.

13. The system according to claim 1, wherein the packet processing hardware is to:
receive an instruction from software running on the local host device to drop any DTLS packets received from the remote networking device prior to offload of the first cryptographic material from the local host device being completed; and
drop second DTLS packets received prior to completing offload of the first cryptographic material from the local host device.

14. The system according to claim 13, further comprising the local host device including a processor to run the software to:
perform a DTLS handshake with a remote host device;
provide the instruction to the local networking device to drop any DTLS packets received from the remote networking device prior to offload of the first cryptographic material from the local host device being completed;
complete the DTLS handshake; and
offload the first cryptographic material to the local networking device after completing the DTLS handshake.

15. The system according to claim 1, wherein:
in response to receiving the first cryptographic material offloaded from the local host device, the packet processing hardware is to generate a DTLS request to a remote host device to commence offload of second cryptographic material to the remote networking device;
the packet processing hardware is to receive a DTLS response from the remote networking device that the second cryptographic material has been offloaded to the remote networking device by the remote host device, the DTLS response being generated by the remote networking device; and
in response to receiving the DTLS response, the packet processing hardware is to commence sending DTLS data messages to the remote networking device.

16. The system according to claim 1, further comprising the local host device including a processor to run software to:
receive a DTLS request generated by the remote networking device requesting to commence offload of the first cryptographic material to the local networking device; and
in response to receiving the DTLS request, offload the first cryptographic material to the local networking device, wherein the packet processing hardware of the local networking device is to generate a DTLS response to the remote networking device indicating that the offload of the first cryptographic material to the local networking device has been completed.

17. The system according to claim 1, wherein the packet processing hardware is to:
in response to receiving the offload of the first cryptographic material from the local host device, generate a first DTLS finished message and send the first DTLS finished message to a remote host device; and
receive a second DTLS finished message generated by the remote networking device indicating that the offload of the first cryptographic material to the remote networking device has been completed.

18. The system according to claim 1, further comprising the local host device including a processor to run software to:
receive a first DTLS finished message from the remote host device; and
offload the first cryptographic material to the local networking device, wherein the packet processing hardware of the local networking device is to:
generate a second DTLS finished message and send the second DTLS finished message to the remote networking device; and
commence sending DTLS data messages to the remote networking device.

19. A host device, comprising:
a processor to run software to:
establish a DTLS connection with a remote host device using a DTLS handshake; and
offload cryptographic material of the DTLS connection to a local networking device; and
an interface to provide the cryptographic material to the local networking device.

20. The device according to claim 19, wherein the software is to:
generate a key update DTLS control message;
provide the key update DTLS control message to the local networking device;
receive an acknowledgment DTLS control message from the local networking device;
retrieve a DTLS sequence number of the key update DTLS control message;
verify that the DTLS sequence number of the key update message corresponds with a DTLS sequence number of the acknowledgement message; and
offload new cryptographic material to the local networking device responsively to verifying that the DTLS sequence number of the key update message corresponds with the DTLS sequence number of the acknowledgement message.

21. The device according to claim 19, wherein the software is to generate DTLS packets with a single DTLS record.

22. The device according to claim 19, wherein the software is to generate DTLS packets with a same padding length.

23. The device according to claim 19, wherein the software is to:
provide an instruction to the local networking device to drop any DTLS packets received from a remote networking device prior to offload of the cryptographic material to the local networking device being completed;
complete the DTLS handshake; and
offload the cryptographic material to the local networking device after completing the DTLS handshake.

24. The device according to claim 19, wherein the software is to:
receive a DTLS request generated by a remote networking device requesting to commence offload of the cryptographic material to the local networking device; and
in response to receiving the DTLS request, offload the cryptographic material to the local networking device.

25. The device according to claim 19, wherein the software is to:
receive a DTLS finished message from the remote host device; and
offload the cryptographic material to the local networking device.

26. A method, comprising:
receiving packets from a local host device;
receiving cryptographic material offloaded from the local host device over a host interface;
performing cryptographic operations on the packets based on the cryptographic material;
generating datagram transport layer security (DTLS) headers including respective DTLS sequence numbers in hardware;
encapsulating the packets with the DTLS headers in hardware; and
a network interface to send the packets with the DTLS headers to a remote networking device over a packet data network.
